(19) United States
(12) Patent Application Publication
(10) Pub. No.: US 2005/0167563 A1
(43) Pub. Date: Aug. 4, 2005

(54) Adjustable hair dryer and mirror assembly

(76) Inventor: Kathy M. Delaney, Palm Beach, FL (US)

Correspondence Address: AKERMAN SENTERFITT, P.O. BOX 3188, WEST PALM BEACH, FL, 33402-3188, US

(21) Appl. No.: 10/936,943

(22) Filed: Sep. 9, 2004

Related U.S. Application Data
(60) Provisional application No. 60/540,506, filed on Jan. 29, 2004.

(51) Int. Cl. F26B 19/00

(52) U.S. Cl. 248/475.1

(57) ABSTRACT

An adjustable hair dryer and mirror assembly includes a base, a linkage of extension arms, the linkage being movably coupled to the base and each extension arm is movably coupled to at least one adjacent extension arm. The assembly also includes a flexible tubing coupled to an extension arm where the flexible tubing has a hair dryer clamp. Also, a mirror is coupled to an extension arm.

### CROSS REFERENCE TO RELATED APPLICATION

The application claims priority to U.S. Provisional Patent Application Ser. No. 60/540,506 filed on Jan. 29, 2004 with the title Personal Accoutrements, the entirety of which is herein incorporated by reference.

### FIELD OF INVENTION

The present invention relates generally to the field of personal preparation devices and, more particularly, apparatuses for holding hair dryers, mirrors, and other personal preparation devices.

### PRIOR ART

Hair dryers have been designed in various shapes and sizes. One of the most common designs of a hair dryer is the gun-shaped design where the hair dryer is shaped like a hand-gun and includes a hand grip portion with a barrel portion extending therefrom and out of which barrel portion hot air is forced. Another type of hair dryer is of a generally cylindrical or barrel shape and is arranged to be gripped at the rear thereof.

Over the years, hair dryers have become smaller, less heavy, more powerful, and even portable. A large number of relatively small, lightweight, hand-held electrical hair dryers are commercially available today. Even with the improvements in size, shape, weight, and functionality, the users are not always able to use the hair dryer optimally.

In order to use consumer hair dryers, the user normally holds the dryer in one hand adjacent to his or her head so that the hot air exiting from the outlet of the dryer flows towards the user's hair. Such a method of use is common for hand held hair dryers. The hand-held operation presents several drawbacks, which in the end, limit the user from reaching their full potential. For example, while holding the hand-held hair dryer, the user may experience muscle fatigue, particularly when the hair dryer must be held in the same position for extended periods. The fatigue can be accelerated and amplified because a portion of the user's arm and their hand are typically above or level with their head, a position to which blood may have difficulties traveling. Further, such awkward and extended positioning of the user's limbs can severely interfere and limit the user's ability to style his or her hair during drying.

Although large, free-standing commercial bonnet-type hair dryers include stands for supporting the hair drying bonnet over the user's head, such stands are not readily available for consumer type hair dryers. Even though some supports have been disclosed for consumer-type devices, no suitable supports are available for supporting and holding conventional consumer-type hand-held hair dryers in adjustable positions adjacent to user's head to free the user's hands for other purposes during the drying operation.

For instance, U.S. patent application Ser. No. 4,225,106 to Eplan is directed to an apparatus for supporting an electrical hair dryer having a hand grip portion and a barrel portion extending therefrom. The Eplan apparatus is representative of the limitations of many of the apparatuses of the prior art. Although the Eplan apparatus frees a hand for other uses during personal preparations, the Eplan apparatus severely limits the positioning of the hair dryer. In order to have the heated air exiting the hair dryer hit the user's hair at a desired angle, the user must adjust the posture of their head to compensate for the lack of motion provided by the Eplan apparatus. Such neck contortions are not only not comfortable, they can be dangerous for some users, such as aged women who are typical users of hair dryers.

Another example of the limitation of limited positioning of a hair dryer is illustrated in U.S. Pat. No. 5,359,461 to Rice et al. The apparatus disclosed provides a support for the hair dryer; however, the user still must contort, twist, and turn their head in order to dry different portions of the their hair.

Further to the limited range of motion provided by the hair dryer holding apparatuses, these designs fail to consider and account for the wide range of factors affecting optimal hair drying. While one factor of holding the hair dryer at the appropriate position for extended periods has been attempted to be addressed by previous devices, none of the devices consider the various optimal positions of a mirror. Importantly, note of these references appreciate that such positioning is dynamic during the personal preparation process. Instead of the user simply standing in front of a stationary mirror, the user needs both an adjustable hair dryer holder and an adjustable apparatus for supporting a mirror. Still further, many of the apparatuses and devices for holding hair dryers require permanent installations and are not mobile for use during travel. Still further, there is a need for not only a portable device, but also a device that is easily assembled and dissembled, which can be compacted for storage.

### SUMMARY OF THE INVENTION

The invention provides users the ability to prepare themselves without the need for holding onto a hair dryer or a mirror. Accordingly, the invention provides an apparatus for holding both a mirror and a hair dryer that can be adjusted to various positions during the personal preparation process. Additionally, the apparatus is designed to fold to a compact configuration for easy storage and can be supported by a cabinet door for convenient availability and easy storage.

In one aspect, the invention provides an adjustable hair dryer and mirror assembly. The assembly may include a base and a linkage of extension arms where the linkage is movably coupled to the base. Each extension arm may be movably coupled to at least one adjacent extension arm. Also, a flexible tubing may be coupled to an extension arm and the flexible tubing may have a hair dryer clamp. A mirror may also be coupled to an extension arm.

In one embodiment, the mirror may include a mirror mount movably coupled to the extension arm and the mirror may be movably coupled to the mirror mount. The mirror mount may be detachably coupled to the extension arm. Additionally, the flexible tubing may be detachably coupled to the extension arm.

In another embodiment, the linkage of extension arms may fold to a planar arrangement having a width of approximately the width of an extension arm. Additionally, the base may be one or more of a detachable base, a base having an aperture for receiving a cylindrical rod, and a combination thereof. The detachable base may include a slot for receiving a mounting portion of a movable coupling and a hook and, the hook may include an aperture for receiving a screw.

In yet another arrangement, the linkage of extension arms and the flexible tubing may independently orientate the mirror and a hair dryer. A cabinet having a door may also be provided where the base is attached to a inner surface of the door. Further, a hair dryer can be provided that is detachably held by the hair dryer clamp and a hair dryer foot control in communication with the hair dryer can be provided. The hair dryer clamp may be one or more of a biased clamp, a cylindrical clamp, a spring biased clamp, and a combination thereof.

In another aspect, the invention provides an adjustable hair dryer and mirror assembly. The assembly may include a hook attachment, a transverse member extending from the hood attachment, a hair dryer bracket depending from the transverse member, a mirror bracket depending from the hair dryer bracketing, and a mirror adjustably held within the mirror bracketing. The mirror may be adjustable in different axes and the assembly may be adapted to receive mirrors of different magnification. The assembly may include a hair dryer detachably held by the hair dryer bracket and a hair dryer foot control in communication with the hair dryer.

Accordingly, it is an object of the subject invention to develop a hair dryer and mirror combination which can be utilized in a variety of different locations, including one's own bathroom and various guest bathrooms as well.

It is another object of the subject invention to provide a compact mirror and hair dryer combination which can be stored within a medicine cabinet or similar closet and used once the cabinet door is opened.

It is but another object of the subject invention to provide a mirror to be used in conjunction with a hair dryer, with the mirror and the hair dryer positioned advantageously one with respect to the other.

It is still another object of the present invention to develop a mirror and hair dryer combination which, while portable, nevertheless can be quickly set up in a semi-permanent fashion in a new environment with a minimum of difficulty.

It is but another object of the subject invention to provide a hair dryer which can be utilized by people of different heights, being adjustable to facilitate its use.

It is still another object of the present invention to provide adequate storage for a hair dryer and mirror combination so that when the unit is not being used it can be efficiently stored and not left laying on a countertop or sink.

It is still one more object of the present invention to have the unit usable within its storage position, such that its position of use is virtually identical with its position of storage.

It is still one more object of the subject invention to have a hair drying holder and mirror which can be utilized with a wide variety of different hair dryers and that mirrors of different magnification can be substituted one for another.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a perspective view of an adjustable hair dryer and mirror assembly in accordance with the inventive arrangements.

FIG. 2 is a perspective view of another embodiment of an adjustable hair dryer and mirror assembly in accordance with the inventive arrangements.

FIG. 3 is a perspective view of the embodiment of FIG. 2 attached to the inner surface of a cabinet in accordance with the inventive arrangements.

FIG. 4A is a view of a detached portion of the embodiment of FIG. 2 in accordance with the inventive arrangements.

FIG. 4B is an opposite view of the detached portion shown in FIG. 4A.

FIG. 5A is an view of a hair dryer clamp in accordance with the inventive arrangements.

FIG. 5B is a view of another embodiment of a hair dryer clamp in accordance with the inventive arrangements.

FIG. 5C is a view of another embodiment of a hair dryer clamp in accordance with the inventive arrangements.

FIG. 6 is an isometric view showing the hair dryer and mirror combination mounted within a cabinet.

FIG. 7 (not to scale) shows a mirror of a different magnification which can be substituted for the mirror of FIG. 6.

FIG. 8 is a side elevational view of the hair dryer assembly of FIG. 6.

FIG. 9 is a cutaway showing alternate attachment structure.

FIG. 10 is a front elevational view of the hair dryer assembly of FIG. 6.

FIG. 11 is a top view of the hair dryer assembly of FIG. 6.

FIG. 12 is a further top view of the hair dryer of FIG. 6 showing various rotational positions that can be utilized by the unit.

### DETAILED DESCRIPTION

In accordance with the inventive arrangements, an adjustable hair dryer and mirror assembly is provided. The assembly is not only adjustable, but it is also configured to fold to a compact configuration for storage and is portable for use during travel. With the assembly, user's can orientate a hair dryer and mirror simultaneously while having both hands free to manipulate their hair and/or apply make-up.

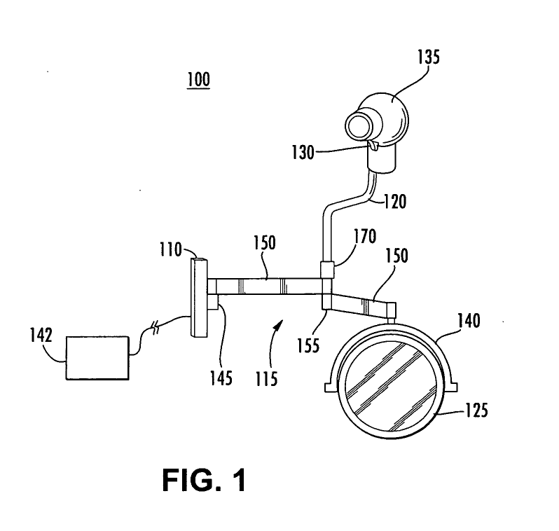

One embodiment of the adjustable hair dryer and mirror assembly 100 is shown in FIG. 1. The assembly includes a base 110, a linkage of extension arms 115, a flexible tubing 120, and a mirror 125. The flexible tubing 120 provides a hair dryer clamp 130 for holding the hair dryer 135. A mirror mount 140 may also be provided.

The linkage of extension arms 115 may be movably coupled to the base 110 with a movable coupling, such as hinge 145. The linkage of extension arms 115 includes multiple extension arms 150 where each extension arm 150 is movable coupled to at least another extension arm 150 with pivot couplings 155. Nevertheless, the movable couplings are not limited to pivot couplings as ball and socket or other rotatable couplings may be used. The linkage of extension arms 115 can be manipulated by the user and extended to the appropriate position during use and folded to a compact arrangement for storage.

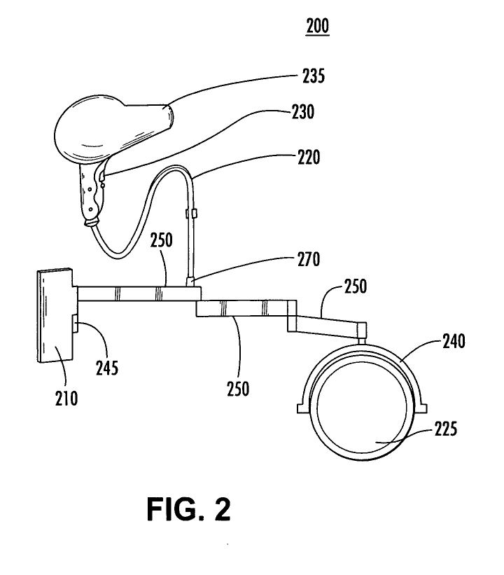

As shown in another embodiment of FIG. 2, the number of extension arms 250 is not limited as any appropriate number may be used. Additionally, multiple extension arms 250 can advantageously provided for a greater extension distance and for further compaction during storage. Additionally, extension arms 250 can be removed and added as needed for further user customization.

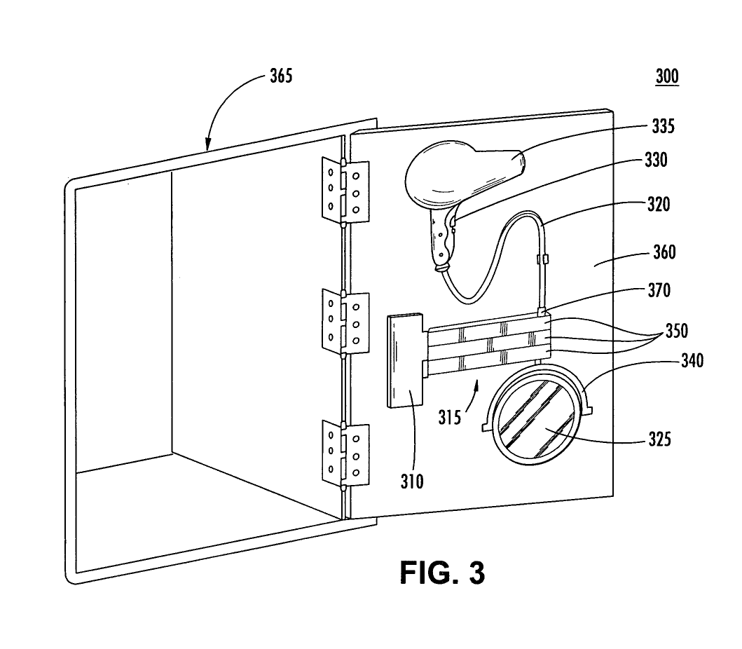

FIG. 3 illustrates the assembly 300 attached to the inner surface 360 of cabinet 365. The linkage of extension arms 315 may fold to a planar arrangement to form a compacted arrangement for storage. In this compact storage arrangement, the extension arms 350 are aligned in generally the same imaginary plane that has a thickness approximately equal to the thickness of an extension arm 350. Thus, although the linkage of extension arms can extend outwards from the cabinet 365 and be moved to the appropriate position, the assembly 300 can be compacted and the cabinet 365 can be closed so that the assembly 300 is no longer in view. Additionally, assembly 300 may be detachable, where the mirror 325, the flexible tubing 320, and the mirror mount 140 are detached and secured to the inner surface 360 of cabinet 365.

With reference to FIGS. 1-3, the flexible tubing 120, 220, or 320 can be coupled to a extension arm 150, 250, or 350. The coupling 170, 270, or 370, can be a movable coupling, such as pivot or ball-and-socket coupling to allow for various orientations. The coupling 370 can be a detachable coupling so that the flexible tubing 320 can be detached and clamped to the cabinet door 360 for storage, or for convenient packing when mobility is needed.

Additionally, the flexible tubing 120, 220, or 320 may be manipulated by a user to orientate the flow of air from the hair dryer 135 to any desired direction and angle. Importantly, the flexible tubing 120, 220, or 320 can include any adjustable and self supporting tubing. For instance, the flexible tubing 120, 220, or 320 can include a flexible plastic skin with an internal, helical wire supporting the skin, along with a relatively rigid, but bendable, annealed stainless steel rod disposed within the tubing and extending along the length of flexible tubing 120, 220, or 320. In another example of the such a flexible tubing, a plurality of snapped together, injection molded links, can be rotatably attached to each other in a ball-and-socket relationship. The flexible tubing 120, 220, or 320 can provide a conduit for wiring to the hair dryer 135, 235, or 335.

With reference to FIG. 1, the mirror 125 can depend from the extension arm 150 via the mirror mount 140. The mirror 125 can be detachably and rotatably mounted at couplings 175, so that a mirror 125 with sides of different reflection magnitudes can be provided. Additionally, the mirrors of various reflection magnitudes can be interchanged with mirror mount 140. Further, not only can the mirror 125 be rotatably mounted to the mirror mount 140, the mirror mount 140 can also be movably coupled the extension member 150. Such multiple movably couplings provide the flexibility for optimal orientation of the mirror 125.

Additionally, a foot control 142, 242 may be provided for controlling the hair dryer 135, 235. The foot control 124, 242 may be in communication with the hair dryer 135, 235 via conventional wiring or can communicate over a suitable wireless protocol, such as blue tooth, the 802.11 family of wireless protocols, or any radio frequency standard. Advantageously, the foot control 142, 242 can allow adjustments in hair dryer operation without the user's hands.

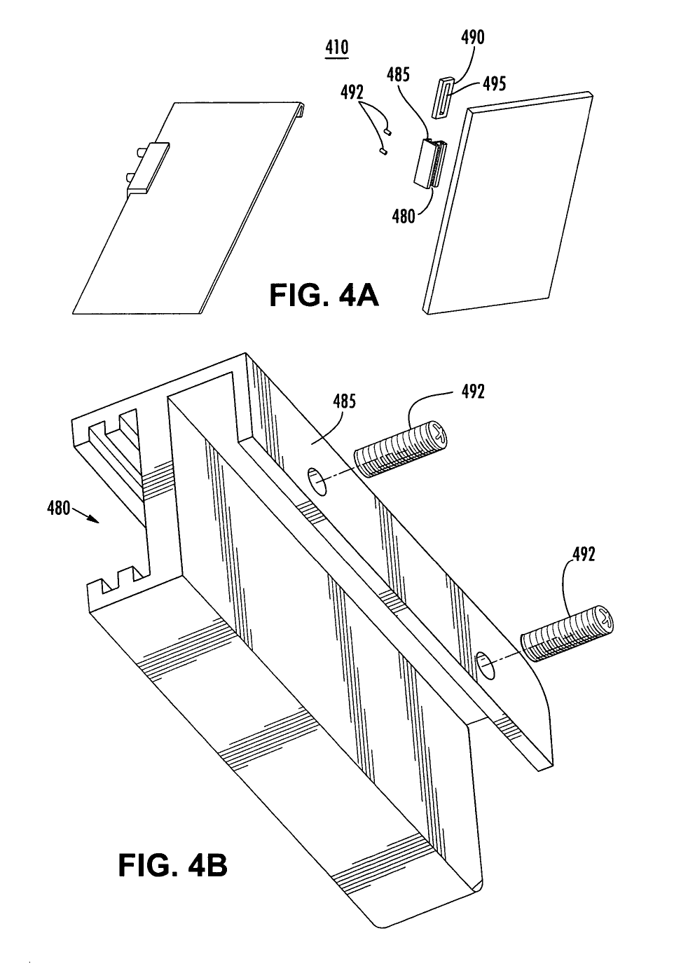

FIGS. 4A and 4B illustrate the base separately from the other components of the hair dryer and mirror assembly. The detachable base 410 may include a slot 480 and a hook 485. The slot 480 is constructed and arranged to receive a mounting portion 490 having a movable coupling 495, which movably couples the linkage of extension arms (not shown). Additionally, the U-shaped portion of hook 485 is constructed and arranged to engage a door, or other support structure, for detachably coupling the base 410 to the door. Screws 492 may be used to further secure the base 410 to the support structure. Such an detachable base 410 can be useful during travel; however, the invention is not limited in this regard as the base 410 can simply include one or more apertures for receiving a cylindrical rod, such as a screw, nail, staple, rivet, and the like, for securing the base 410 to a support structure.

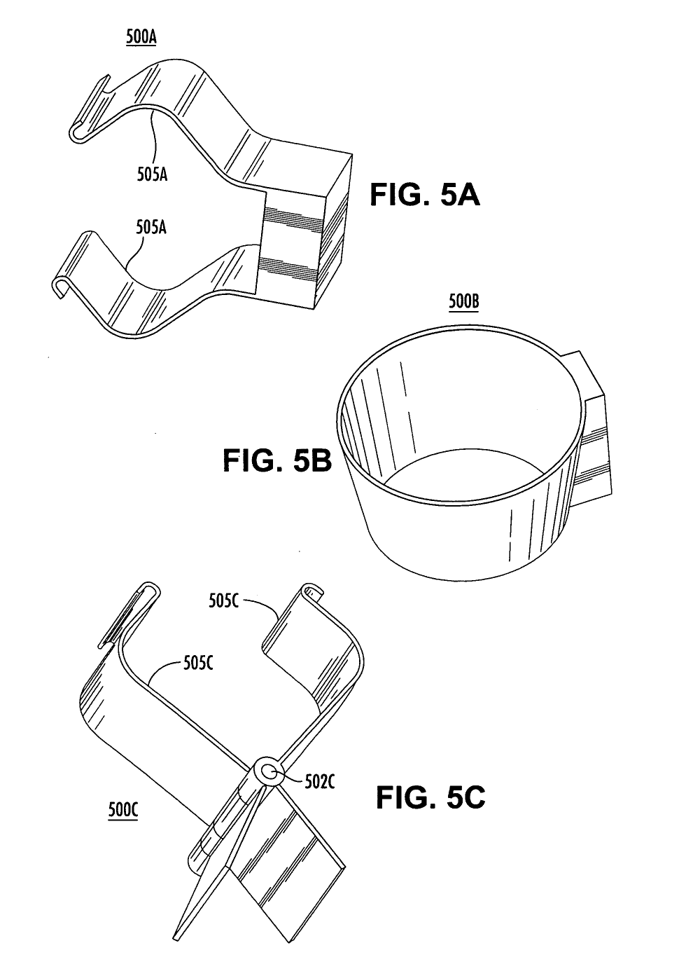

FIGS. 5A, 5B, and 5C illustrate various embodiments of the hair dryer clamp 500A, 500B, and 500C. FIG. 5A illustrates one embodiment where the clamp 500A is constructed of a semi-rigid material, such as metal, plastic, ceramic, or a combination thereof. The prongs 505A of the clamp are spaced so that the prongs 505A will be slightly flexed by the insertion of a hair dryer (not shown). Thus, the prongs 505A will be geometrically biased to secure the hair dryer.

FIG. 5B illustrates a cylindrical clamp 500B where the diameter of the cylinder is slightly smaller than the diameter of the hair dryer (not shown) that it will clamp. Accordingly, the hair dryer will fit snuggly in the clamp 500B. Also, the diameter of the clamp 500B can decrease in the direction of hair dryer insertion to accommodate hair dryers of various sizes with the same clamp 500B.

FIG. 5C illustrates a hair dryer clamp 500C that is spring biased with spring 502C. The spring 502C forces the prongs 505C to forcefully clamp a hair dryer (not shown). Advantageously, the spring biased hair dryer clamp 500C can accommodate hair dryers of various sizes.

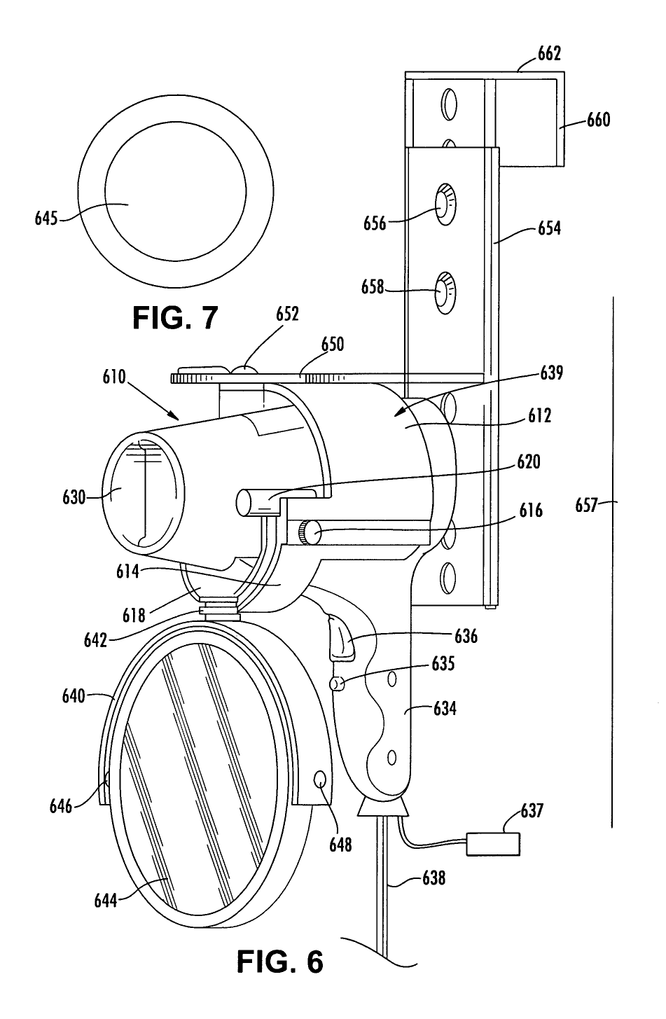

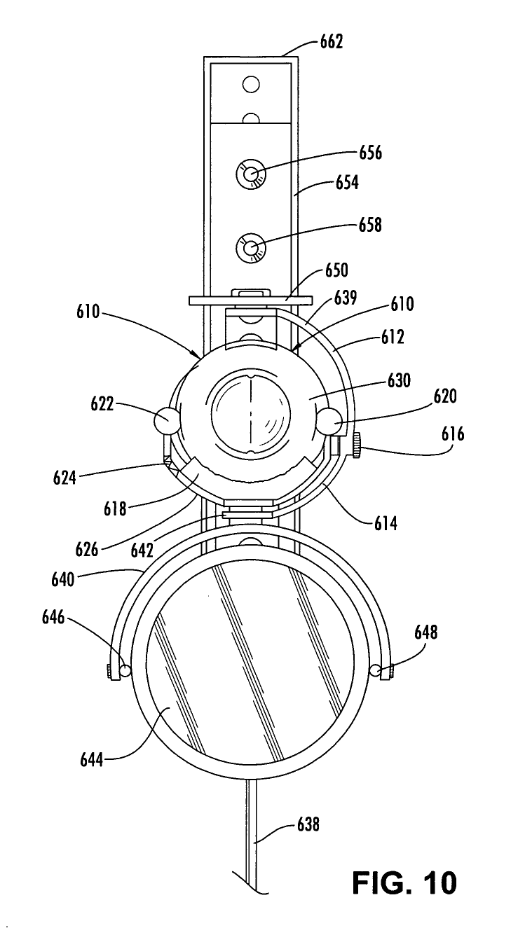

Another embodiment of the hair dryer and mirror assembly is illustrated in FIGS. 6-12. A hair dryer 610 is shown mounted within upper bracket 612 connected to lower bracket 614 via connector 616. Foam 618 provides cushion support for hair dryer 610 and friction knobs 620,622 assist in stabilizing dryer 610. A flexible portion of inner bracket arm 626 enables friction knob 622 to co-act with stationary friction knob 620, creating a securement mechanism for dryer 610. Inner bracket arm 626 has a flexible portion 624 to give inner bracket arm 626 a spring-like quality to enable friction knob 622 to create a sturdy counterbalance to friction knob 620 with the hair dryer 610 always held securely in place. It will be appreciated that the friction fit between knobs 620, 622 can be easily overcome by removing the dryer 610 from its position, as will be discussed subsequently.

Hair dryer 610 is shown having air nozzle 630, handle 634, speed control 635, and switch 36 representing a typical small hair dryer 610 which is readily associated with traveling. A power source is applied through cord 638, which is to be utilized with any standard outlet.

Depending below the hair dryer holding assembly 639 comprising brackets 612, 614, and 626, is found a mirror frame 640 attachable to the hair dryer assembly by connector 642. The mirror 644 is mounted within frame 640 via rotatable connectors 646 and 648.

Mirror 645 of FIG. 7 represents one of a plurality of mirrors of different magnification which can be substituted for mirror 644.

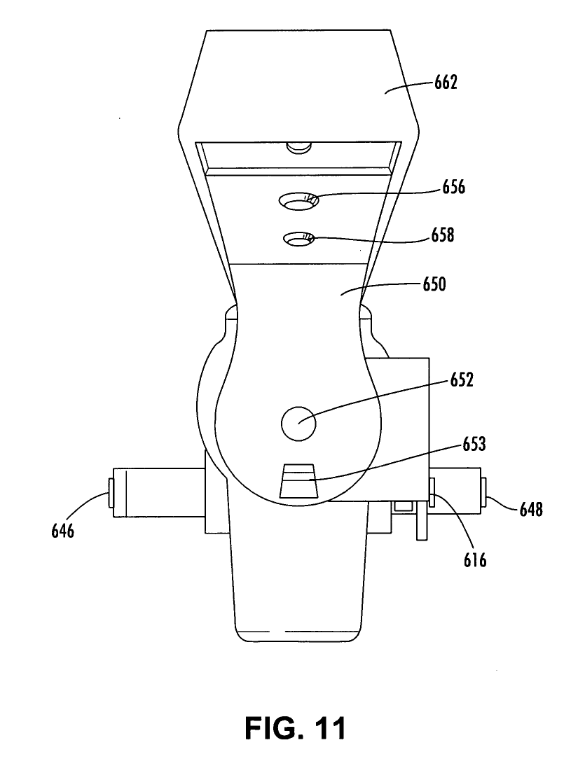

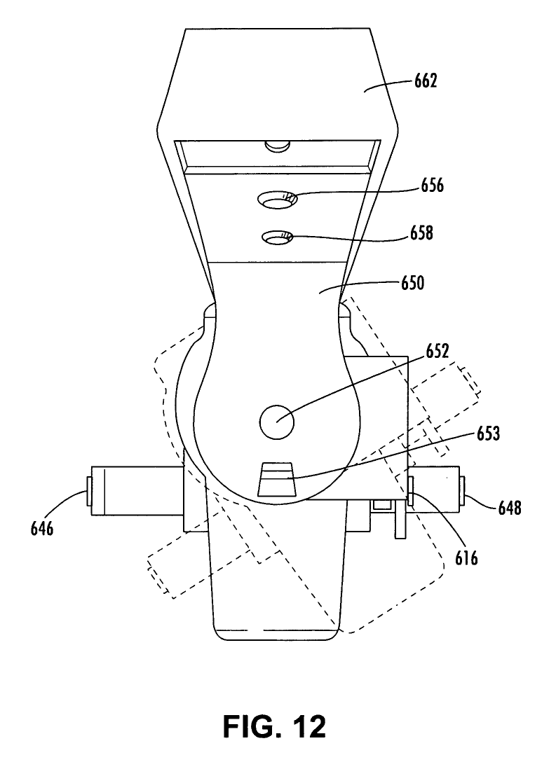

As can be appreciated from FIGS. 11 and 12, the mirror (not shown) is rotatable about a horizontal axis through connectors 646, 648 and also rotatable about a vertical axis extending downwardly through connector 642.

Upper housing bracket 612 is mounted to transverse bar 650 by clamp screw 652. As best seen in FIG. 8, a snap 653 for extension can be utilized to bring the hair dryer assembly further forward, if desired. An upper bracket 654 extending upwardly from bar 650 includes screw holes 656 and 658 (for screws 657 and 659) for mounting the unit on a desired wall or other surface area, such as the inside wall of a cabinet which is shown schematically as 657. Also, a vertical member 660 extends from horizontal extension 662 of bracket member 654 to create a hook-like device to enable the unit to be placed over a ledge, door, or other potential mounting structure. This feature is important for the portability of the assembly, which can be temporarily hung for use when one travels.

It will be appreciated that hair dryer 610 can be held within the assembly 639 comprising primarily of brackets 612, 614 and 626 to enable the hair dryer 610 to be used wherever mounted. It is contemplated that one preferred spot for mounting will be in a medicine cabinet 657 or other cabinet within one's bathroom. The unit is compact enough so that it can fit within a medicine cabinet such that the cabinet can easily be closed with the hair dryer unit within.

When in a cabinet or otherwise, the hair dryer 610 can be used in hands-free fashion with the mirror 644 in close association so that the two can be used together. By turning on the switch 636, the hair dryer 610 will be useful in its present position without the need to handle it outside of the assembly. Also, the unit can be accompanied by a foot pedal 637 appropriately connected to enable foot control of the on and off switching means. If it is desired to remove the hair dryer 610, this can be easily accomplished by pivoting the unit around clamp screw 652 to release the dryer 610 to the side so that it can be removed from its assembly 639 and used by holding by hand.

Through the positioning of mirror 644 and connectors 646 and 648, it will be appreciated that slight adjustments to the mirror can be made so that it is either raised or lowered or turned sideways slightly to provide assistance to the user as it is being used.

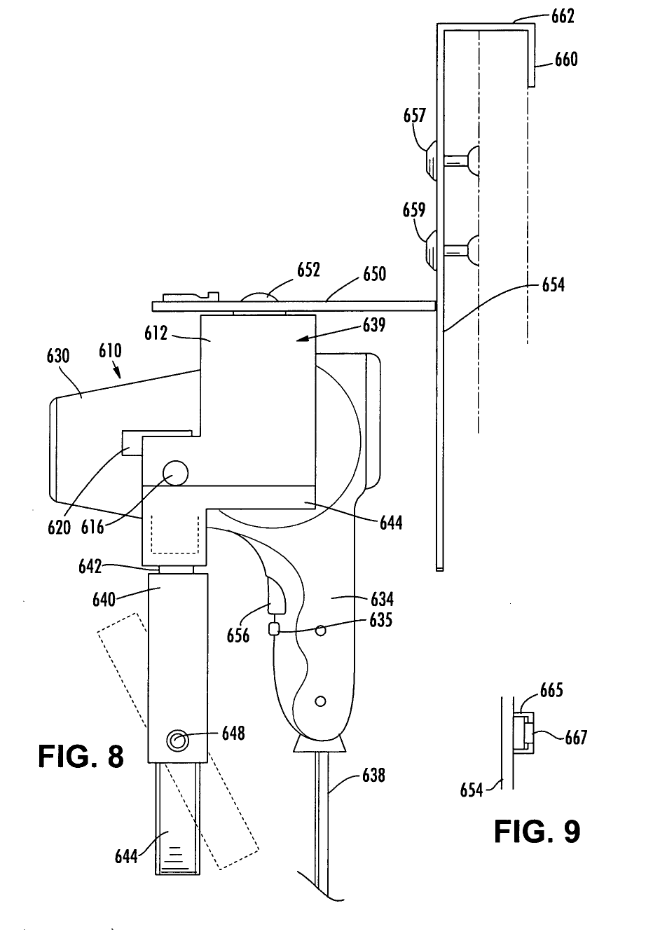

When one desires to travel, the entire unit can be removed quickly from the transverse bracket 650 by undoing clamp screw 652. As shown in FIG. 9, alternate attachment means is contemplated such as engaging clamp means which includes member 665 mounted on member 654 which engages member 667 mounted to the medicine cabinet or other wall. The assembly can thus be horizontally slid onto the wall connecting means for semi-permanent attachment. Of course, for travel, the assembly can be slid off member 667 and hook means 660 and 662 used to temporarily attach the unit to a medicine cabinet door or other ledge in a guest facility such as a hotel room.

It will be appreciated that the present invention may be adapted for utilization beyond the specific environments discussed herein. Accordingly, the present invention is not limited to the specific embodiments described herein, but is defined by the scope and spirit of the following claims.

1. An adjustable hair dryer and mirror assembly, comprising:
a base;
a linkage of extension arms, the linkage being movably coupled to the base, wherein each extension arm is movably coupled to at least one adjacent extension arm;
a flexible tubing coupled to an extension arm, the flexible tubing having a hair dryer clamp; and
a mirror coupled to an extension arm.

2. The assembly according to claim 1, wherein the linkage of extension arms fold to a planar arrangement.

3. The assembly according to claim 1, wherein the mirror includes a mirror mount movably coupled to the extension arm and the mirror is movably coupled to the mirror mount.

4. The assembly according to claim 1, wherein the flexible tubing is detachably coupled to the extension arm.

5. The assembly according to claim 3, wherein the mirror mount is detachably coupled to the extension arm.

6. The assembly according to claim 1, wherein the base is selected from the group consisting of a detachable base, a base having an aperture for receiving a cylindrical rod, and a combination thereof.

7. The assembly according to claim 6, wherein the detachable base includes a slot for receiving a mounting portion of a movable coupling and a hook.

8. The assembly according to claim 7, wherein the hook includes an aperture for receiving a screw.

9. The assembly according to claim 1, wherein the linkage of extension arms and the flexible tubing independently orientate the mirror and a hair dryer.

10. The assembly according to claim 1, further including a cabinet having a door, wherein the base is attached to an inner surface of the door.

11. The assembly according to claim 1, further including a hair dryer detachably held by the hair dryer clamp and a hair dryer foot control in communication with the hair dryer.

12. The assembly according to claim 1, wherein the hair dryer clamp is selected from the group consisting of a biased clamp, a cylindrical clamp, a spring biased clamp, and a combination thereof.

13. An adjustable hair dryer and mirror assembly, comprising:
a detachable base having a slot for receiving a mounting portion of a movable coupling and a hook;
a linkage of extension arms, the linkage being movably coupled to the base with the movable coupling, wherein each extension arm is movably coupled to at least one adjacent extension arm;
a flexible tubing detachably coupled to an extension arm, the flexible tubing having a hair dryer clamp; and
a mirror coupled to an extension arm.

14. An adjustable hair dryer and mirror assembly, comprising:
a hook attachment;
a transverse member extending from the hood attachment;
a hair dryer bracket depending from the transverse member;
mirror bracket depending from the hair dryer bracketing; and
a mirror adjustably held within the mirror bracketing.

15. The assembly according to claim 14, wherein the mirror is adjustable in different axes.

16. The assembly according to claim 14, adapted to receive mirrors of different magnification.

17. The assembly according to claim 14, further including a hair dryer detachably held by the hair dryer bracket and a hair dryer foot control in communication with the hair dryer.
